(19) United States
(12) Patent Application Publication
(10) Pub. No.: US 2015/0100420 A1
(43) Pub. Date: Apr. 9, 2015

(54) METHOD AND SYSTEM FOR MAKING A TARGET OFFER TO AN AUDIENCE USING AUDIENCE FEEDBACK

(71) Applicant: MasterCard International Incorporated, Purchase, NY (US)

(72) Inventors: Douglas Wilbur VAN HORN, St. Louis, MO (US); Lisa Maria Bongiovi, Middle Village, NY (US)

(73) Assignee: MasterCard International Incorporated, Purchase, NY (US)

(21) Appl. No.: 14/046,032

(22) Filed: Oct. 4, 2013

(51) Int. Cl. G06Q 30/02; G06F 17/30

(52) U.S. Cl. CPC G06Q 30/0255; G06Q 30/0269; G06Q 30/0261; G06F 17/30091; G06F 17/3053; G06F 17/30345
USPC 705/14.53

(57) ABSTRACT

A method for real-time ranking of offers for consumer distribution includes: storing a plurality of offer data entries, each entry including an offer identifier and offer data; storing a consumer profile, the profile including data related to a consumer including a consumer identifier and consumer characteristics; storing a plurality of distribution data entries, each entry including data related to an offer previously distributed to the consumer including an offer identifier, offer data, and indication of at least one of: receipt, viewing, and acceptance of the offer; identifying a ranking of the offer data entries based on the respective included offer data, the consumer characteristics, and the offer data and indication included in each of the distribution data entries; and transmitting the offer data included in at least one of the offer data entries based on the rank to a computing device associated with the consumer.

### FIELD

The present disclosure relates to the real-time ranking of offers for consumer distribution, specifically the use of consumer characteristics, previous consumer actions, and consumer audiences to rank or score offers for distribution to a consumer.

### BACKGROUND

Offers, such as coupons, discounts, deals, etc. are often used by merchants to drive additional business. In some instances, merchants may provide offers to consumers at a discount or even a financial loss, with the expectation that a consumer that redeems the offer will purchase other goods or services, either at the same time or over time as a repeat customer. In more recent times, offer distribution services and other offer providers have begun operating. Many of these services operate by purchasing offers from a merchant and then selling the offers to a consumer for a profit. The offer provider gets to keep the profit, while the merchant receives the benefit of increased business without expending time and resources to advertise and distribute offers that lead to the resulting business.

In order to increase the likelihood of an offer being purchased and/or redeemed, it is often a goal of merchants and other offer providers to target offers to consumers that they believe are more likely to take advantage of or otherwise react well to the offer. In some instances, merchants or offer providers may request information from a consumer, such as their preferences, for the future selection of offers. In other instances, a merchant or offer provider may repeat an offer to a consumer if the consumer previously accepted the offer. However, some consumers may not consent to the storing of such data personally related to the consumer. In addition, merchants and offer providers often lack additional data, as well as the resources to obtain and analyze such data, to achieve stronger targeting of offers.

Thus, there is a need for a technical solution to provide more accurate targeting of offers for consumer distribution via real-time optimization while maintaining consumer privacy and security.

### SUMMARY

The present disclosure provides a description of systems and methods for ranking of offers for consumer distribution.

A method for real-time ranking of offers for consumer distribution includes: storing, in an offer database, a plurality of offer data entries, wherein each offer data entry includes data related to an offer for the purchase of goods or services including at least an offer identifier and offer data; storing, in a consumer database, a consumer profile, wherein the consumer profile includes data related to a consumer including at least a consumer identifier and one or more consumer characteristics; storing, in a distribution database, a plurality of distribution data entries, wherein each distribution data entry includes data related to an offer previously distributed to the related consumer including at least an offer identifier, offer data, and an indication of at least one of: receipt, viewing, and acceptance of the offer by the related consumer; identifying, by a processing device, a ranking of the plurality of offer data entries stored in the offer database based on the respective included offer data, the one or more consumer characteristics, and the offer data and indication included in each of the plurality of distribution data entries stored in the distribution database; and transmitting, by a transmitting device, the offer data included in at least one of the plurality of offer data entries based on the identified rank to a computing device associated with the related consumer.

A method for ranking offers for consumer distribution includes: storing, in an offer database, a plurality of offer data entries, wherein each offer data entry includes data related to an offer for the purchase of goods or services including at least an offer identifier and offer data; storing, in a consumer database, a consumer profile, wherein the consumer profile includes data related to a consumer including at least a consumer identifier and one or more consumer characteristics; storing, in a distribution database, a plurality of distribution data entries, wherein each distribution data entry includes data related to an offer previously distributed to the related consumer including at least an offer identifier, offer data, and an indication of at least one of: receipt, viewing, and acceptance of the offer by the related consumer; generating, by a processing device, a scoring model configured to score an offer to be distributed to the related consumer based on the one or more consumer characteristics, the offer data and indication included in each distribution data entry of the plurality of distribution data entries, and the offer data associated with the offer to be distributed; applying, by the processing device, the generated scoring model to each offer data entry of the plurality of offer data entries to identify a score for each respective offer data entry; identifying, by the processing device, at least one offer data entry for distribution based on the identified score; and transmitting, by a transmitting device, the offer data included in each of the identified at least one offer data entry to a computing device associated with the related consumer.

A system for real-time ranking of offers for consumer distribution includes an offer database, a consumer database, a distribution database, a processing device, and a transmitting device. The offer database is configured to store a plurality of offer data entries, wherein each offer data entry includes data related to an offer for the purchase of goods or services including at least an offer identifier and offer data. The consumer database is configured to store a consumer profile, wherein the consumer profile includes data related to a consumer including at least a consumer identifier and one or more consumer characteristics. The distribution database is configured to store a plurality of distribution data entries, wherein each distribution data entry includes data related to an offer previously distributed to the related consumer including at least an offer identifier, offer data, and an indication of at least one of: receipt, viewing, and acceptance of the offer by the related consumer. The processing device is configured to identify a ranking of the plurality of offer data entries stored in the offer database based on the respective included offer data, the one or more consumer characteristics, and the offer data and indication included in each of the plurality of distribution data entries stored in the distribution database. The transmitting device is configured to transmit the offer data included in at least one of the plurality of offer data entries based on the identified rank to a computing device associated with the related consumer.

A system for ranking offers for consumer distribution includes an offer database, a consumer database, a distribution database, a processing device, and a transmitting device. The offer database is configured to store a plurality of offer data entries, wherein each offer data entry includes data related to an offer for the purchase of goods or services including at least an offer identifier and offer data. The consumer database is configured to store a consumer profile, wherein the consumer profile includes data related to a consumer including at least a consumer identifier and one or more consumer characteristics. The distribution database is configured to store a plurality of distribution data entries, wherein each distribution data entry includes data related to an offer previously distributed to the related consumer including at least an offer identifier, offer data, and an indication of at least one of: receipt, viewing, and acceptance of the offer by the related consumer. The processing device is configured to: generate a scoring model configured to score an offer to be distributed to the related consumer based on the one or more consumer characteristics, the offer data and indication included in each distribution data entry of the plurality of distribution data entries, and the offer data associated with the offer to be distributed; apply the generated scoring model to each offer data entry of the plurality of offer data entries to identify a score for each respective offer data entry; and identify at least one offer data entry for distribution based on the identified score. The transmitting device is configured to transmit the offer data included in each of the identified at least one offer data entry to a computing device associated with the related consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for real-time ranking of offers for consumer distribution in accordance with exemplary embodiments.

FIG. 2 is a block diagram illustrating the processing server of FIG. 1 for the real-time ranking and scoring for offers and the distribution thereof to consumers in accordance with exemplary embodiments.

FIG. 3 is a block diagram illustrating the distribution database of FIG. 2 for the storage of distribution data entries for the distribution of ranked offers to consumers in accordance with exemplary embodiments.

FIG. 4 is a flow diagram illustrating a process for the real-time ranking of offers and the distribution thereof to a consumer in accordance with exemplary embodiments.

FIG. 5 is a flow chart illustrating an exemplary method for real-time ranking of offers for consumer distribution in accordance with exemplary embodiments.

FIG. 6 is a flow chart illustrating an exemplary method for ranking offers for consumer distribution in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 102 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

Microsegment—A representation of a group of consumers that is granular enough to be valuable to advertisers, marketers, offer providers, merchants, retailers, etc., but still maintains a high level of consumer privacy without the use or obtaining of personally identifiable information. Microsegments may be given a minimum or a maximum size. A minimum size of a microsegment would be at a minimum large enough so that no entity could be personally identifiable, but small enough to provide the granularity needed in a particular circumstance. Microsegments may be defined based on geographical or demographical information, such as age, gender, income, marital status, postal code, income, spending propensity, familial status, etc., behavioral variables, or any other suitable type of data, such as discussed herein. The granularity of a microsegment may be such that behaviors or data attributed to members of a microsegment may be similarly attributable or otherwise applied to consumers having similar characteristics. In some instances, microsegments may be grouped into an audience. An audience may be any grouping of microsegments, such as microsegments having a common data value, microsegments encompassing a plurality of predefined data values, etc. In some instances, the size of a microsegment may be dependent on the application. An audience based on a plurality of microsegments, for instance, might have ten thousand entities, but the microsegments would be aggregated when forming the audience and would not be discernible to anyone having access to an audience. Additional detail regarding microsegments and audiences may be found in U.S. Published Patent Application No. 2013/0024242, entitled “Protecting Privacy in Audience Creation,” by Curtis Villars et al., published on Jan. 24, 2013, which is herein incorporated by reference in its entirety.

### System for Real-Time Ranking of Offers for Consumer Distribution

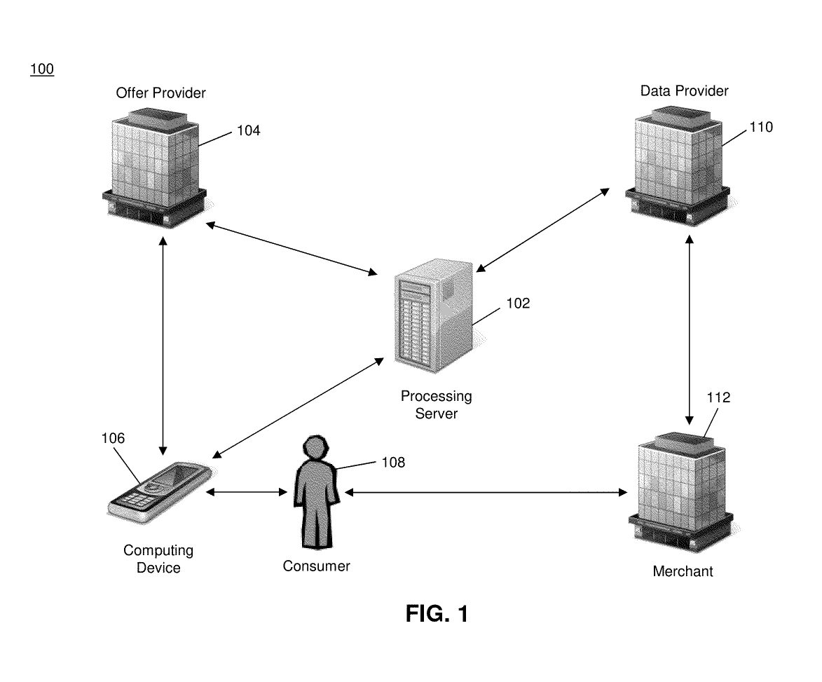

FIG. 1 illustrates a system 100 for the real-time scoring and ranking of offers for consumer distribution based on consumer characteristics and previous consumer actions towards distributed offers.

A processing server 102, discussed in more detail below, may be configured to rank and score offers for consumer distribution. The processing server 102 may receive a plurality of offers from an offer provider 104 or other third party. The processing server 102 may store data associated with each offer in an offer database, discussed in more detail below. Each received offer may include offer data associated with the offer, such as an offer name, offer description, discount amount, offer type, offer category, merchant name, merchant category, manufacturer name, manufacturer category, offer provider, product name, product description, start date, end date, offer quantity, and limitations on redemption.

The processing server 102 may be configured to distribute an offer to a computing device 106. The computing device 106 may be any computing device suitable for performing the functions as disclosed herein, such as a desktop computer, laptop computer, tablet computer, cellular phone, smart phone, etc. The computing device 106 may be associated with a consumer 108. In some instances, the processing server 102 may be configured to distribute offers directly to the consumer 108. In order to identify an offer for distribution to the computing device 106 and/or consumer 108, the processing server 102 may identify a stored consumer profile, discussed in more detail below, associated with one of the computing device 106 and the consumer 108.

Each consumer profile may include a consumer identifier and consumer characteristics of the associated consumer 108 (e.g., or the consumer 108 associated with the associated computing device 106). The consumer characteristics may include demographic characteristics, social network data, geographic location data, consumer preferences, purchase history, and offer redemption history. The consumer characteristics may be received by the processing server 102 from one or more data providers 110. In an exemplary embodiment, the consumer profile may not include any personally identifiable information. In another embodiment, the consumer profile may be a microsegment that may be associated with a plurality of consumers 108 such that no consumer associated with the microsegment may be personally identifiable.

For each offer distributed from the processing server 102 to the computing device 106 (e.g., or the consumer 108), the processing server 102 may store a distribution data entry into a distribution database, discussed in more detail below. The distribution data entry may include offer data for the offer and an indication of if the consumer 108 received, viewed, and/or accepted the offer. In some embodiments, the distribution data entry may also include an indication of whether the consumer 108 redeemed the offer. The processing server 102 may identify if the consumer 108 receives, views, or accepts the offer via a notification received from the computing device 106 when the consumer 108 performs the respective action.

The consumer 108 may redeem a received offer at a participating merchant 112. When the consumer 108 redeems the offer, the merchant 112 may notify a third party, such as the offer provider 104, that provided the redeemed offer, a data provider 110 (e.g., an acquirer, a payment network, a data acquisition agency, etc.), or the processing server 102. The processing server 102 may receive an indication of the redemption of the offer by the consumer 108 (e.g., from the merchant 112 or the third party) and may update the respective distribution data entry.

To identify an offer for distribution, the processing server 102 may be configured to rank offers for distribution to the consumer 108. The processing server 102 may rank each offer stored in the offer database based on the offer data for each respective offer, the consumer characteristics stored in a consumer profile associated with the consumer 108, and the behavior of the consumer 108 towards previous offers based on the indications included in each distribution data entry corresponding to offers previously distributed to the consumer 108. The processing server 102 may identify one or more of the ranked offers based on their ranking, and then distribute the offer or offers to the computing device 106 and/or the consumer 108 accordingly.

Once the offer or offers have been distributed, the processing server 102 may store a new distribution data entry in the distribution database corresponding to the distributed offer(s). The processing server 102 may receive information from the computing device 106 and/or the merchant 112 or third party indicating actions taken by the consumer 108 towards the offer, and update the distribution data entry accordingly.

As the distribution data entry is updated, and/or as the consumer profile for the consumer 108 is updated (e.g., new characteristic data, transaction data, social network data, etc., is received) the processing server 102 may be configured to update the ranking of offers to be distributed in real-time. The real-time update of the offer ranking may enable the processing server 102 to distribute offers with an increased likelihood of acceptance, purchase, and/or redemption. In addition, by distributing offers based on ranking, the processing server 102 may operate with increased efficiency compared to traditional systems for distributing offers. This could, in turn, result in less expense in the distribution of offers to consumers, be less intrusive (e.g., and thus potentially more successful) to consumers, and also protect merchants from the over-distribution of offers.

Furthermore, by storing consumer profiles without the inclusion of personally identifiable information, consumers 108 may receive targeted offers without intrusion into personal privacy. The use of microsegments to group consumers may further increase the success of distributed offers by enabling the processing server 102 to distribute offers to consumers 108 based on behaviors of consumers with similar attributes that may be included in the same microsegment and/or audience. In addition, utilizing microsegments may even further increase the privacy offered to consumers 108 due to the protection offered by microsegments.

The processing server 102 may also be configured to utilize consumer characteristic data and consumer activity data that has been received and/or updated within a predetermined period of time prior to the ranking of offers, such as data received within days, weeks or 1, 3, 6, or 12 months. Using recent data, which may be updated at any time and then ranking subsequently updated in real-time, may lead to more accurate selection of offers that may change along with a consumer's tastes, situation, experiences, etc.

In some embodiments, the processing server 102 may rank offers based on offer scores, which may be identified using one or more scoring models. Scoring models may be generated by the processing server 102 for each consumer 108 or microsegment. In some embodiments, scoring models may operate off of the data included in consumer profiles and the distribution database. In other embodiments, scoring models may be generated prior to each ranking and/or offer distribution based on the data included in the consumer profiles and distribution database. In both embodiments, the scoring model and/or offer scores may be updated in real-time as data is received, which may result in several benefits to each party as discussed above.

### Processing Device

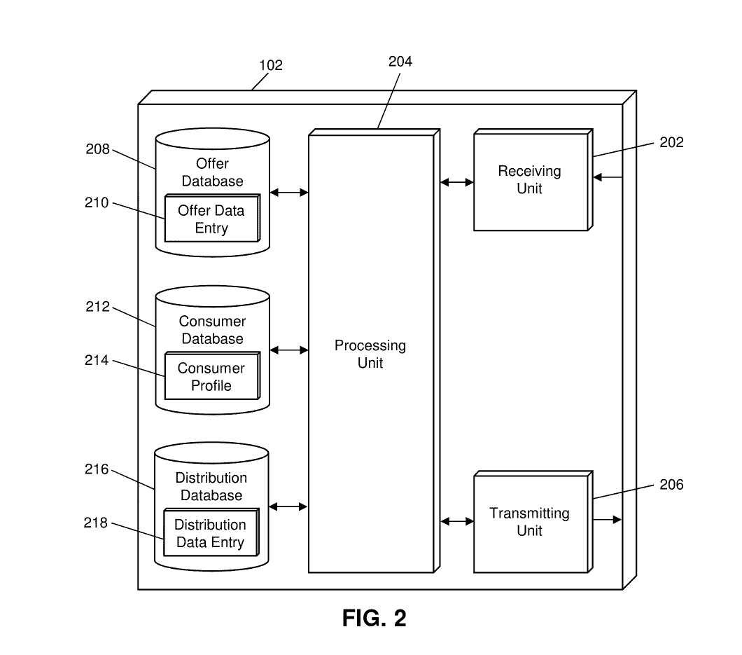

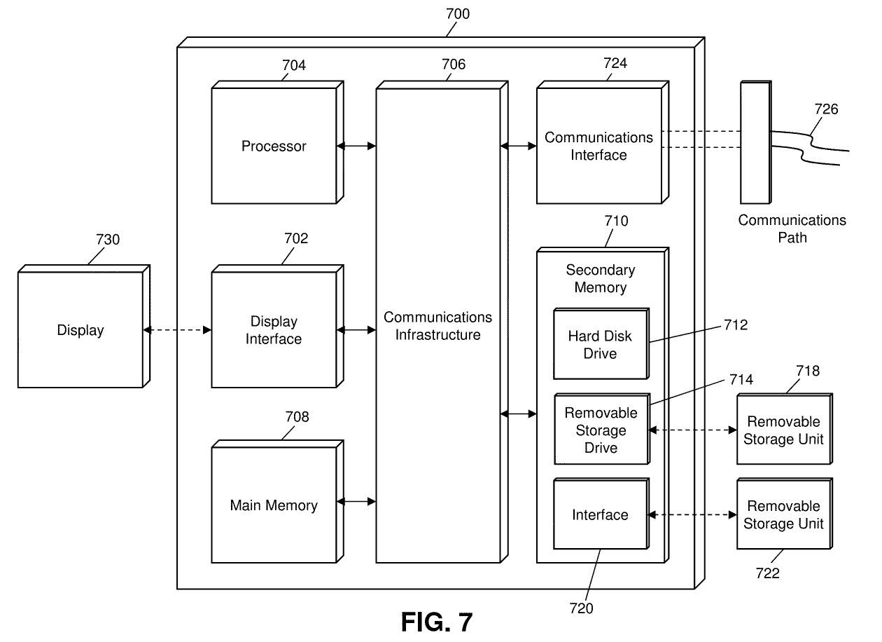

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may be configured to receive information for one or more offers for distribution to consumers, wherein the offer information includes an offer identifier and offer data. The processing server 102 may also include a processing unit 204. The processing unit 204 may be any type of processing unit suitable for performing the functions as disclosed herein as will be apparent to persons having skill in the relevant art. The processing unit 204 may be configured to store the received offer information in an offer database 208 as one or more plurality of offer data entries 210.

Each offer data entry 210 may include data related to an offer including offer data and an offer identifier. The offer identifier may be a unique value associated with the offer used for identification, such as an identification number, a universal product code, a serial number, etc. The offer data may be data associated with the offer such as an offer name, offer description, discount amount, offer type, offer category, merchant name, merchant category, manufacturer name, manufacturer category, offer provider, product name, product description, start date, end date, offer quantity, and limitations on redemption. The offer data may further include conditions for distribution of the related offer, such as conditions related to consumer characteristics and/or behavior.

The processing unit 204 may also be configured to generate and store a plurality of consumer profiles 214 in a consumer database 212. Each consumer profile may include data related to one or more consumers 108 including at least a consumer identifier and one or more consumer characteristics. The consumer identifier may be a unique value used for identification of the respective consumer profile 214. The consumer identifier may be an identifier of the computing device 106 (e.g., a media access control address or device identifier), an identification number, a username, a phone number, a payment account number, a name, a street address, or any other suitable type of identifier as will be apparent to persons having skill in the relevant art.

In some instances, a consumer profile 214 may include a plurality of consumer identifiers, such as if the consumer profile 214 corresponds to a microsegment of a plurality of consumers 108. In other instances, each consumer profile 214 may include a single consumer identifier corresponding to a microsegment. In such an instance, the processing server 102 may also include a look-up table or other suitable mechanism for mapping a consumer identifier of a microsegment to the corresponding plurality of consumers 108 and/or computing devices 106.

The consumer characteristics may include data associated with the related consumer 108 or consumers. The consumer characteristics may include social network data, such as data obtained from Facebook®, Twitter®, LinkedIn®, and other social networks. In an exemplary embodiment, the social network data may be obtained with the consent of the corresponding consumer 108, or otherwise may be not personally identifiable. The consumer characteristics may also include demographic characteristics, such as age, gender, marital status, residential status, income, employment, education, familial status, etc. In an exemplary embodiment, the demographic characteristics may be bucketed or otherwise modified such as to render the consumer profile 214 not personally identifiable.

The consumer characteristics may further include consumer preferences (e.g., provided by the consumer 108), geographic location data (e.g., of the computing device 106, such as provided by the consumer 108 and/or a computing network operator), transaction history (e.g., provided by a payment network), offer redemption history (e.g., provided by merchants 112, data providers 110, or other entities), or any other suitable type of information as will be apparent to persons having skill in the relevant art. In an exemplary embodiment, none of the consumer characteristics may be personally identifiable. In some instances, the processing server 102 may receive data for a microsegment of consumers including the consumer 108 such that any received data may not be personally identifiable.

The processing server 102 may also include a distribution database 216 configured to store a plurality of distribution data entries 218. Each distribution data entry 218 may be configured to store data related to an offer previously distributed to a consumer 108 including, as discussed in more detail below, at least an offer identifier, offer data, and an indication of at least one of: receipt, viewing, and acceptance of the offer by the related consumer.

The receiving unit 202 may be configured to receive a request from the consumer 108 (e.g., via the computing device 106) or other source requesting the distribution of an offer for the consumer 108, where the request includes a consumer identifier. The processing unit 204 may identify a consumer profile 214 in the consumer database 212 associated with the consumer 108 based on the received consumer identifier. The processing unit 204 may further identify each distribution data entry 218 included in the distribution database 216 associated with the identified consumer profile 214. In some instances, the processing unit 204 may only identify those distribution data entries 218 including activity conducted by the consumer 108 during a predetermined period of time. Limiting the consumer activity to a period of time prior to the distribution of a new offer may, in some instances, provide more accurate and/or more suitable ranking of offers.

The processing unit 204 may be configured to rank offer data entries 210 in the offer database 208 based on the consumer characteristics included in the identified consumer profile 214, the offer data included in each of the respective offer data entries 210, and the offer data and indication included in each of the identified distribution data entries 218. The processing unit 204 may then identify one or more of the offer data entries 210 based on their rank for transmission to the consumer 108.

The processing server 102 may include a transmitting unit 206. The transmitting unit 206 may be configured to transmit data over one or more networks via one or more network protocols. The transmitting unit 206 may transmit the identified one or more offers to the consumer 108 and/or the computing device 106. Methods suitable for transmitting offer data to a consumer 108 and/or computing device 106 may include e-mail, short message service (SMS) message, multimedia message service (MMS) message, an application program executed by the computing device 106, traditional mail, telephone, or any other suitable method as will be apparent to persons having skill in the relevant art. In some instances, the consumer profile 214 may include a desired method of communication for use by the transmitting unit 206 when transmitting offer data to the associated consumer 108.

In some embodiments, the receiving unit 202 may be configured to receive an indication of the receipt, viewing, acceptance, and/or redemption of the distributed one or more offers. The processing unit 204 may generate a new distribution data entry 218 in the distribution database 216 corresponding to each of the one or more distributed offers, and may update the included indication of consumer activity accordingly. In some instances, the processing unit 204 may update the rank of the offer data entries 210 in the offer database 208 based on the updated consumer activity. In another instance, the processing unit 204 may update the rank of the offer data entries 210 subsequent to updating the consumer characteristics in the consumer profile 214 when the receiving unit 202 receives additional and/or updated data.

In some embodiments, the processing unit 204 may also be configured to generate a scoring model configured to score an offer to be distributed to the consumer 108 and/or the computing device 106. The scoring model may be based on, or configured to use data including, the consumer characteristics included in the identified consumer profile 214, the offer data included in each of the respective offer data entries 210, and the offer data and indication included in each of the identified distribution data entries 218. The processing unit 204 may then apply the generated scoring model to each offer data entry 210 included in the offer database 208 to identify a score for each offer data entry 210. The processing unit 204 may identify one or more offers based on the scores, which may then be transmitted to the consumer 108 and/or computing device 106 by the transmitting unit 206.

### Distribution Database

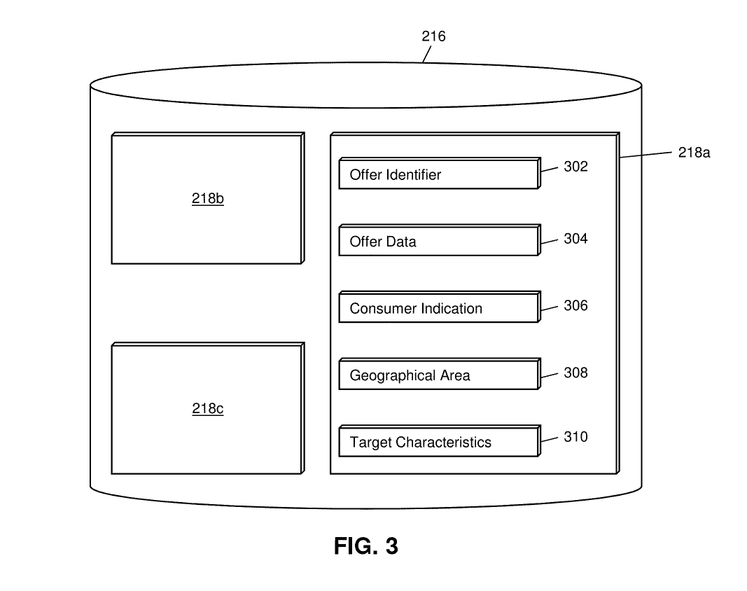

FIG. 3 is an illustration of the distribution database 216. The distribution database 216 may store a plurality of distribution data entries 218, illustrated in FIG. 3 as distribution data entries 218a, 218b, and 218c. Each distribution data entry 218 may include data related to an offer previously distributed to a consumer 108 and may include an offer identifier 302, offer data 304, and a consumer indication 306. In some embodiments, each distribution data entry 218 may further include a geographic area 308 and/or target characteristics 310.

The offer identifier 302 may be a unique value associated with the distributed offer, such as an identification number. The offer data 304 may be data associated with the related offer, such as at least one of: offer name, offer description, discount amount, offer type, offer category, merchant name, merchant category, manufacturer name, manufacturer category, offer provider, product name, product description, start date, end date, offer quantity, and limitations on redemption.

The consumer indication 306 may be an indication of whether or not the consumer 108 has received, viewed, and/or accepted the related offer. In some embodiments, the consumer indication 306 may also indicate if the consumer 108 has redeemed the related offer. Additional consumer activity regarding the related offer may also be included in the consumer indication 306 as will be apparent to persons having skill in the relevant art, such as sharing of the offer via a social network.

The geographical area 308 may be a geographic area associated with the related offer such that the related offer may be distributed to the consumer 108 if the consumer 108 is identified as being inside of or in proximity of the geographical area 308. Methods and systems for identifying the geographic location of a consumer 108 will be apparent to persons having skill in the relevant art, such as identifying the geographic location of the computing device 106 associated with the consumer 108 using the global positioning system, a wireless network connection, cellular network triangulation, direct input by the consumer 108, etc.

The target characteristics 310 may be target consumer characteristics associated with the related offer, which may be used when ranking or scoring the related offer for its distribution to the consumer 108. The target characteristics 310 may be provided by the offer provider 104 when providing the offer to the processing server 102, by the merchant 112 with whom the offer may be redeemed, or by the processing unit 204 of the processing server 102 (e.g., based on the offer data and/or the consumer activity of other similar offers).

### Process for Ranking and Distributing Consumer Offers

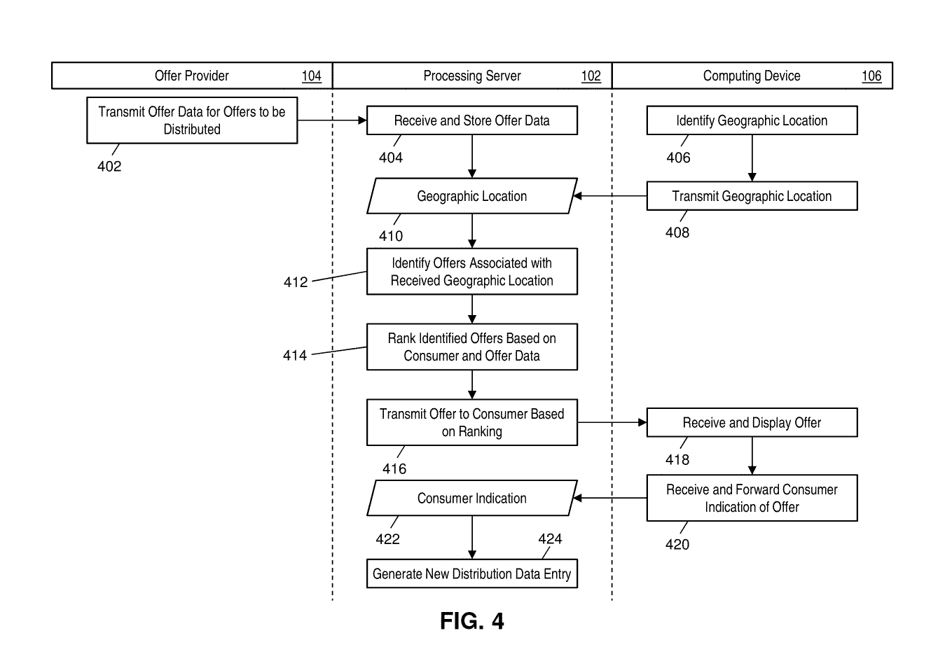

FIG. 4 illustrates a process for the ranking of consumer offers for distribution to a consumer based on past consumer activity and consumer characteristics.

In step 402, the offer provider 104 may transmit offer data for offers to be distributed to consumers to the processing server 102. The offer data may include an offer identifier and data associated with the offer. In step 404, the receiving unit 202 of the processing server 102 may receive the information for the offers and store the information as a plurality of offer data entries 210 in the offer database 208. In step 406, the computing device 106 associated with the consumer 108 (e.g., or a network operator associated with the computing device 106) may identify the geographic location of the computing device 106. Methods and systems suitable for identifying the geographic location of a computing device 106 will be apparent to persons having skill in the relevant art.

In step 408, the computing device 106 (e.g., and/or the network operator) may transmit the geographic location to the processing server 102. In step 410, the receiving unit 202 of the processing server 102 may receive the geographic location. In step 412, the processing unit 204 of the processing server 102 may identify offer data entries 210 in the offer database 208 that are associated with the geographic location of the computing device 106. For example, the processing unit 204 may identify only those offers that may be redeemed within a predetermined distance of the identified geographic location, offers that are targeted to consumers in the identified geographic location, etc.

It will be apparent to persons having skill in the relevant art the steps 406-412 for filtering the offers that may be distributed to the consumer 108 based on a geographic location may be optional steps. In some embodiments, additional or alternative criteria may be used to filter offer data entries 210 for ranking and potential distribution to the consumer 108, such as date and/or time (e.g., for seasonal offers, weeknight only offers, early bird offers, etc.), weather conditions, etc.

In step 414, the processing unit 204 of the processing server 102 may rank the identified offers based on consumer characteristics for the consumer 108 in a consumer profile 214 associated with the consumer 108, offer data for each respective identified offer, and consumer indications 306 and offer data 304 for each distribution data entry 218 in the distribution database 216 associated with the consumer 108. In some embodiments, ranking the identified offers may further include generating a scoring model, applying the scoring model to each offer data entry 210 to obtain a score, and then ranking the identified offers based on their respective scores.

In step 416, the transmitting unit 206 of the processing server 102 may transmit offer data for one or more offers to the computing device 106 based on their respective ranks. In some instances, the number of offers transmitting to the computing device 106 may be selected by the offer provider 104, processing server 102, or the consumer 108. In step 418, the computing device 106 may receive the offer data and may display the offer or offers to the consumer 108. In step 420, the computing device 106 may receive and/or identify consumer activity, such as whether the consumer 108 viewed an offer and/or accepted an offer for future redemption, and may forward an indication of the activity to the processing server 102.

In step 422, the receiving unit 202 of the processing server 102 may receive the indication of the consumer activity for the distributed offer or offers. In step 424, the processing unit 204 may generate a new distribution data entry 218 for each distributed offer including at least the offer data 304 and offer identifier 302 for the distributed offer the consumer indication 306 as received from the computing device 106. In some embodiments, the process may further include the updating of the ranks for each identified offer data entry 210 based on the new distribution data entry or entries 218.

### Exemplary Method for Real-Time Ranking of Offers for Consumer Distribution

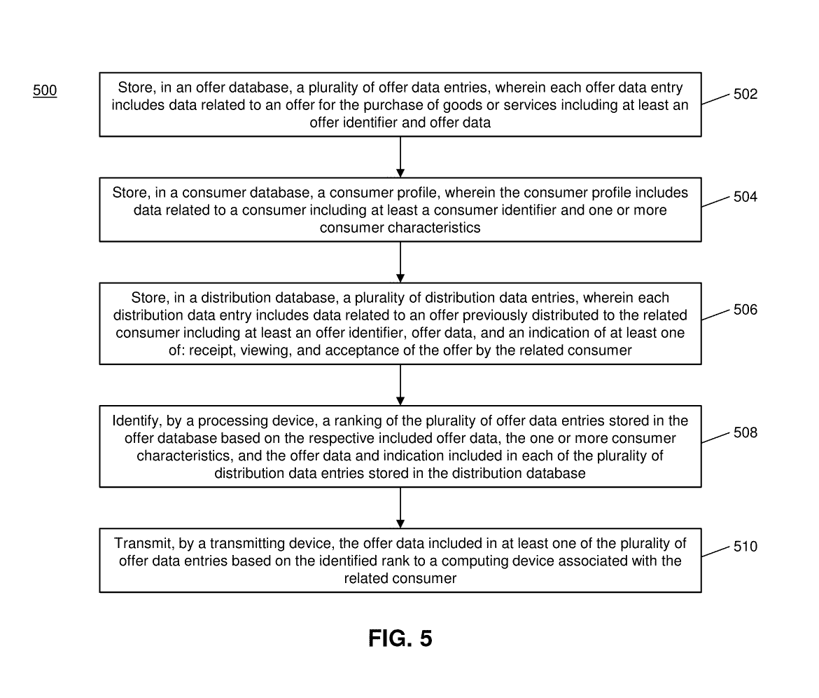

FIG. 5 illustrates a method 500 for the real-time ranking of offers for consumer distribution based on consumer activity for previously distributed offers and consumer characteristics.

In step 502, a plurality offer data entries (e.g., the offer data entries 210) may be stored in an offer database (e.g., the offer database 208), wherein each offer data entry 210 includes data related to an offer for the purchase of goods or services including at least an offer identifier and offer data. In one embodiment, the offer data may include at least one of: offer name, offer description, discount amount, offer type, offer category, merchant name, merchant category, manufacturer name, manufacturer category, offer provider, product name, product description, start date, end date, offer quantity, and limitation on redemption.

In step 504, a consumer profile (e.g., the consumer profile 214) may be stored, in a consumer database (e.g., the consumer database 212), wherein the consumer profile 214 includes data related to a consumer (e.g., the consumer 108) including at least a consumer identifier and one or more consumer characteristics. In one embodiment, the one or more consumer characteristics may include at least one of: social network data, geographic location data, demographic data, consumer preferences, transaction history, and offer redemption history associated with the related consumer 108.

In step 506, a plurality of distribution data entries (e.g., the distribution data entries 218) may be stored, in a distribution database (e.g., the distribution database 216), wherein each distribution data entry 218 includes data related to an offer previously distributed to the related consumer 108 including at least an offer identifier (e.g., the offer identifier 302), offer data (e.g., the offer data 304), and an indication (e.g., the consumer indication 306) of at least one of: receipt, viewing, and acceptance of the offer by the related consumer.

In step 508, a ranking of the plurality of offer data entries 210 stored in the offer database 208 may be identified, by a processing device (e.g., the processing unit 204) based on the respective included offer data, the one or more consumer characteristics, and the offer data 304 and consumer indication 306 included in each of the plurality of distribution data entries 218 stored in the distribution database 216. In step 510, the offer data included in at least one of the plurality of offer data entries 210 may be transmitted, by a transmitting device (e.g., the transmitting unit 206) to a computing device (e.g., the computing device 106) associated with the related consumer 108 based on the respective identified rank. In one embodiment, the method 500 may further include: receiving, by a receiving unit 202, a geographic location of the computing device 106 associated with the related consumer 108, wherein each offer data entry 210 further includes a geographic area, and the ranking of the plurality of offer data entries 210 is further based on the received geographic location of the computing device 106 and the geographic area included in each offer data entry 210 of the plurality of offer data entries.

In another embodiment, the method 500 may further include: receiving, by a receiving device (e.g., the receiving unit 202), an indication of at least one of: receipt, viewing, and acceptance of the offer related each of the at least one of the plurality of offer data entries transmitted to the computing device 106; and adding, to the distribution database 216, a new distribution data entry 218 corresponding to each offer transmitted to the computing device 106, including at least the offer identifier and offer data included in the corresponding offer data entry and the received indication of at least one of: receipt, viewing, and acceptance of the respective offer. In a further embodiment, the method 500 may even further include updating, by the processing unit 204, the ranking of the plurality of offer data entries 210 stored in the offer database 208 based on the new distribution data entries 218 added to the distribution database 216.

### Exemplary Method for Ranking Offers for Consumer Distribution

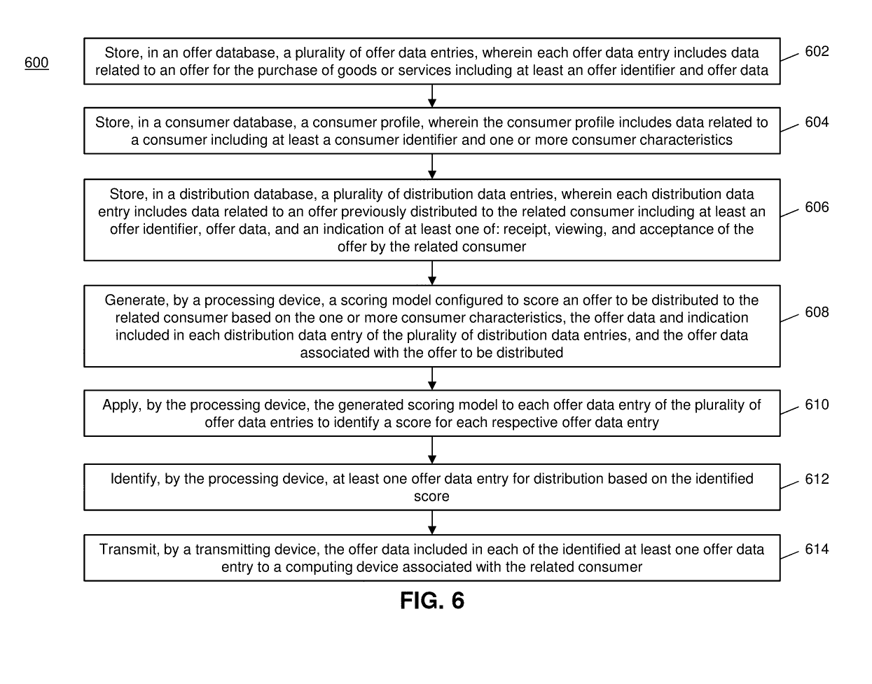

FIG. 6 illustrates a method 600 for the ranking of offers for consumer distribution using a scoring model based on consumer characteristics and activity.

In step 602, a plurality offer data entries (e.g., the offer data entries 210) may be stored in an offer database (e.g., the offer database 208), wherein each offer data entry 210 includes data related to an offer for the purchase of goods or services including at least an offer identifier and offer data. In one embodiment, the offer data may include at least one of: offer name, offer description, discount amount, offer type, offer category, merchant name, merchant category, manufacturer name, manufacturer category, offer provider, product name, product description, start date, end date, offer quantity, and limitation on redemption.

In step 604, a consumer profile (e.g., the consumer profile 214) may be stored, in a consumer database (e.g., the consumer database 212), wherein the consumer profile 214 includes data related to a consumer (e.g., the consumer 108) including at least a consumer identifier and one or more consumer characteristics. In one embodiment, the one or more consumer characteristics may include at least one of: social network data, geographic location data, demographic data, consumer preferences, transaction history, and offer redemption history associated with the related consumer 108.

In step 606, a plurality of distribution data entries (e.g., the distribution data entries 218) may be stored, in a distribution database (e.g., the distribution database 216), wherein each distribution data entry 218 includes data related to an offer previously distributed to the related consumer 108 including at least an offer identifier (e.g., the offer identifier 302), offer data (e.g., the offer data 304), and an indication (e.g., the consumer indication 306) of at least one of: receipt, viewing, and acceptance of the offer by the related consumer.

In step 608, a processing device (e.g., the processing unit 204), may generate a scoring model configured to score an offer to be distributed to the related consumer 108 based on the one or more consumer characteristics, the offer data 304 and consumer indication 306 included in each distribution data entry 218 of the plurality of distribution data entries, and the offer data associated with the offer to be distributed.

In step 610, the generated scoring model may be applied, by the processing device (e.g., the processing unit 204), to each offer data entry 210 of the plurality of offer data entries to identify a score for each respective offer data entry. In step 612, the processing unit 204 may identify at least one offer data entry 210 for distribution based on the identified score.

In step 614, the offer data included in each of the identified at least one offer data entry 210 may be transmitted, by a transmitting device (e.g., the transmitting unit 206) to a computing device (e.g., the computing device 106) associated with the related consumer 108. In one embodiment, the method 600 may further include: receiving, by a receiving device (e.g., the receiving unit 202), a geographic location of the computing device 106 associated with the related consumer 108, wherein each offer data entry 210 further includes a geographic area, and each of the at least one offer data entry 210 identified for distribution includes a geographic area associated with the received geographic location.

In another embodiment, the method 600 may further include: receiving, by a receiving device (e.g., the receiving unit 202), an indication of at least one of: receipt, viewing, and acceptance of the offer related to each of the identified at least one offer data entry; and adding, to the distribution database 216, a new distribution data entry 218 corresponding to each offer transmitted to the computing device 106, including at least the offer identifier and offer data included in the corresponding offer data entry 210 and the received indication of at least one of: receipt, viewing, and acceptance of the respective offer. In a further embodiment, the method 600 may even further include updating, by the processing unit 204, the scoring model based on the new distribution data entries 218 added to the distribution database 216.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communication infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive, the removable storage unit 718 may be a floppy disk. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for real-time ranking of offers for consumer distribution. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for real-time ranking of offers for consumer distribution, comprising:
storing, in an offer database, a plurality of offer data entries, wherein each offer data entry includes data related to an offer for the purchase of goods or services including at least an offer identifier and offer data;
storing, in a consumer database, a consumer profile, wherein the consumer profile includes data related to a consumer including at least a consumer identifier and one or more consumer characteristics;
storing, in a distribution database, a plurality of distribution data entries, wherein each distribution data entry includes data related to an offer previously distributed to the related consumer including at least an offer identifier, offer data, and an indication of at least one of: receipt, viewing, and acceptance of the offer by the related consumer;
identifying, by a processing device, a ranking of the plurality of offer data entries stored in the offer database based on the respective included offer data, the one or more consumer characteristics, and the offer data and indication included in each of the plurality of distribution data entries stored in the distribution database; and
transmitting, by a transmitting device, the offer data included in at least one of the plurality of offer data entries based on the identified rank to a computing device associated with the related consumer.

2. The method of claim 1, further comprising:
receiving, by a receiving device, an indication of at least one of: receipt, viewing, and acceptance of the offer related to each of the at least one of the plurality of offer data entries transmitted to the computing device; and
adding, to the distribution database, a new distribution data entry corresponding to each offer transmitted to the computing device, including at least the offer identifier and offer data included in the corresponding offer data entry and the received indication of at least one of: receipt, viewing, and acceptance of the respective offer.

3. The method of claim 2, further comprising:
updating, by the processing device, the ranking of the plurality of offer data entries stored in the offer database based on the new distribution data entries added to the distribution database.

4. The method of claim 1, wherein the one or more consumer characteristics includes at least one of: social network data, geographic location data, demographic data, consumer preferences, transaction history, and offer redemption history associated with the related consumer.

5. The method of claim 1, further comprising:
receiving, by a receiving device, a geographic location of the computing device associated with the related consumer, wherein
each offer data entry further includes a geographic area, and
the ranking of the plurality of offer data entries is further based on the received geographic location of the computing device and the geographic area included in each offer data entry of the plurality of offer data entries.

6. The method of claim 1, wherein the offer data includes at least one of: offer name, offer description, discount amount, offer type, offer category, merchant name, merchant category, manufacturer name, manufacturer category, offer provider, product name, product description, start date, end date, offer quantity, and limitations on redemption.

7. A method for ranking offers for consumer distribution, comprising:
storing, in an offer database, a plurality of offer data entries, wherein each offer data entry includes data related to an offer for the purchase of goods or services including at least an offer identifier and offer data;
storing, in a consumer database, a consumer profile, wherein the consumer profile includes data related to a consumer including at least a consumer identifier and one or more consumer characteristics;
storing, in a distribution database, a plurality of distribution data entries, wherein each distribution data entry includes data related to an offer previously distributed to the related consumer including at least an offer identifier, offer data, and an indication of at least one of: receipt, viewing, and acceptance of the offer by the related consumer;
generating, by a processing device, a scoring model configured to score an offer to be distributed to the related consumer based on the one or more consumer characteristics, the offer data and indication included in each distribution data entry of the plurality of distribution data entries, and the offer data associated with the offer to be distributed;
applying, by the processing device, the generated scoring model to each offer data entry of the plurality of offer data entries to identify a score for each respective offer data entry;
identifying, by the processing device, at least one offer data entry for distribution based on the identified score; and
transmitting, by a transmitting device, the offer data included in each of the identified at least one offer data entry to a computing device associated with the related consumer.

8. The method of claim 7, further comprising:
receiving, by a receiving device, an indication of at least one of: receipt, viewing, and acceptance of the offer related to each of the identified at least one offer data entry; and
adding, to the distribution database, a new distribution data entry corresponding to each offer transmitted to the computing device, including at least the offer identifier and offer data included in the corresponding offer data entry and the received indication of at least one of: receipt, viewing, and acceptance of the respective offer.

9. The method of claim 8, further comprising:
updating, by the processing device, the scoring model based on the new distribution data entries added to the distribution database.

10. The method of claim 7, wherein the one or more consumer characteristics includes at least one of: social network data, geographic location data, demographic data, consumer preferences, transaction history, and offer redemption history associated with the related consumer.

11. The method of claim 7, further comprising:
receiving, by a receiving device, a geographic location of the computing device associated with the related consumer, wherein
each offer data entry further includes a geographic area, and
each of the at least one offer data entry identified for distribution includes a geographic area associated with the received geographic location.

12. The method of claim 1, wherein the offer data includes at least one of: offer name, offer description, discount amount, offer type, offer category, merchant name, merchant category, manufacturer name, manufacturer category, offer provider, product name, product description, start date, end date, offer quantity, and limitations on redemption.

13. A system for real-time ranking of offers for consumer distribution, comprising:
an offer database configured to store a plurality of offer data entries, wherein each offer data entry includes data related to an offer for the purchase of goods or services including at least an offer identifier and offer data;
a consumer database configured to store a consumer profile, wherein the consumer profile includes data related to a consumer including at least a consumer identifier and one or more consumer characteristics;
a distribution database configured to store a plurality of distribution data entries, wherein each distribution data entry includes data related to an offer previously distributed to the related consumer including at least an offer identifier, offer data, and an indication of at least one of: receipt, viewing, and acceptance of the offer by the related consumer;
a processing device configured to identify a ranking of the plurality of offer data entries stored in the offer database based on the respective included offer data, the one or more consumer characteristics, and the offer data and indication included in each of the plurality of distribution data entries stored in the distribution database; and
a transmitting device configured to transmit the offer data included in at least one of the plurality of offer data entries based on the identified rank to a computing device associated with the related consumer.

14. The system of claim 13, further comprising:
a receiving device configured to receive an indication of at least one of: receipt, viewing, and acceptance of the offer related to each of the at least one of the plurality of offer data entries transmitted to the computing device, wherein
the processing device is further configured to add, to the distribution database, a new distribution data entry corresponding to each offer transmitted to the computing device, including at least the offer identifier and offer data included in the corresponding offer data entry and the received indication of at least one of: receipt, viewing, and acceptance of the respective offer.

15. The system of claim 14, wherein the processing device is further configured to update the ranking of the plurality of offer data entries stored in the offer database based on the new distribution data entries added to the distribution database.

16. The system of claim 13, wherein the one or more consumer characteristics includes at least one of: social network data, geographic location data, demographic data, consumer preferences, transaction history, and offer redemption history associated with the related consumer.

17. The system of claim 13, further comprising:
a receiving device configured to receive a geographic location of the computing device associated with the related consumer, wherein
each offer data entry further includes a geographic area, and
the ranking of the plurality of offer data entries is further based on the received geographic location of the computing device and the geographic area included in each offer data entry of the plurality of offer data entries.

18. The system of claim 13, wherein the offer data includes at least one of:
offer name, offer description, discount amount, offer type, offer category, merchant name, merchant category, manufacturer name, manufacturer category, offer provider, product name, product description, start date, end date, offer quantity, and limitations on redemption.

19. A system for ranking offers for consumer distribution, comprising:
an offer database configured to store a plurality of offer data entries, wherein each offer data entry includes data related to an offer for the purchase of goods or services including at least an offer identifier and offer data;
a consumer database configured to store a consumer profile, wherein the consumer profile includes data related to a consumer including at least a consumer identifier and one or more consumer characteristics;
a distribution database configured to store a plurality of distribution data entries, wherein each distribution data entry includes data related to an offer previously distributed to the related consumer including at least an offer identifier, offer data, and an indication of at least one of: receipt, viewing, and acceptance of the offer by the related consumer;
a processing device configured to
generate a scoring model configured to score an offer to be distributed to the related consumer based on the one or more consumer characteristics, the offer data and indication included in each distribution data entry of the plurality of distribution data entries, and the offer data associated with the offer to be distributed,
apply the generated scoring model to each offer data entry of the plurality of offer data entries to identify a score for each respective offer data entry, and
identify at least one offer data entry for distribution based on the identified score; and
a transmitting device configured to transmit the offer data included in each of the identified at least one offer data entry to a computing device associated with the related consumer.

20. The system of claim 19, further comprising:
a receiving device configured to receive an indication of at least one of: receipt, viewing, and acceptance of the offer related to each of the identified at least one offer data entry, wherein
the processing device is further configured to add, to the distribution database, a new distribution data entry corresponding to each offer transmitted to the computing device, including at least the offer identifier and offer data included in the corresponding offer data entry and the received indication of at least one of: receipt, viewing, and acceptance of the respective offer.

21. The system of claim 20, wherein the processing device is further configured to update the scoring model based on the new distribution data entries added to the distribution database.

22. The system of claim 19, wherein the one or more consumer characteristics includes at least one of: social network data, geographic location data, demographic data, consumer preferences, transaction history, and offer redemption history associated with the related consumer.

23. The system of claim 19, further comprising:
a receiving device configured to receive a geographic location of the computing device associated with the related consumer, wherein
each offer data entry further includes a geographic area, and
each of the at least one offer data entry identified for distribution includes a geographic area associated with the received geographic location.

24. The system of claim 19, wherein the offer data includes at least one of: offer name, offer description, discount amount, offer type, offer category, merchant name, merchant category, manufacturer name, manufacturer category, offer provider, product name, product description, start date, end date, offer quantity, and limitations on redemption.
